(19) United States
(12) Patent Application Publication
(10) Pub. No.: US 2006/0239680 A1
(43) Pub. Date: Oct. 26, 2006

(54) Device for introducing an objective onto a camera

(75) Inventor: Uwe Weber, Aalen (DE)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: CARL ZEISS AG

(21) Appl. No.: 11/359,844

(22) Filed: Feb. 22, 2006

(30) Foreign Application Priority Data
Feb. 23, 2005 (DE) 10200508568.7

(51) Int. Cl. G03B 17/00

(52) U.S. Cl. 396/529

(57) ABSTRACT

There is provided a device for introducing an objective onto a camera. The device includes a base element and a bridge element, where the objective can be moved back and forth in a direction of the camera by the bridge element on the base element, and where a support element is disposed between the base element and the objective. There is also provided an apparatus for capturing images having a camera and an objective, where the apparatus includes the aforementioned a device.

The invention concerns a device for introducing an objective onto a camera having a base element and a bridge element, wherein the objective can be moved back and forth in the direction of the camera by means of the bridge element on the base element.

The invention also concerns an apparatus for capturing images having a camera and an objective.

It is known generally that small lightweight objectives can be held in film-type cameras by means of a bayonet mount. Large, heavy objectives should be supported so that neither the camera nor the objective will be damaged by the torque that arises. In this case, the objective absolutely must not break off from the camera.

It is known to dispose two rods under a camera, so that different accessories, e.g., drive motors, extension attachments, etc. can be attached to these rods. A bridge element, on which the objective is then supported, can also be fastened to these two rods. This bridge element is positioned under the center of gravity of the objective. It is a disadvantage herewith that the objective tends to tip even with the slightest displacement of the center of gravity, whereupon the objective and parts of the camera can be damaged. In the worst case, the objective falls off the rods and shatters. It may also be problematical to place the objective in constricted places or in unusual positions.

It is thus the object of the invention to create a device for introducing an objective onto a camera, with which a secure mounting of the objective can be achieved. Another object consists of creating an apparatus for capturing images, in which the camera and the objective can be mounted securely to one another.

The object is solved by the features of claim 1 as well as of claim 17. In the device according to the invention for introducing an objective onto a camera, a support element is disposed between the base element and the objective. The apparatus according to the invention for capturing images has a device according to the invention for introducing the objective onto a camera. The objective is mounted securely by means of the invention. A good image quality can be attained.

Advantageous configurations of the invention are found in the subclaims.

In a preferred embodiment, the base element is joined with connecting means, in particular with a tripod stand common to the base element and the camera, or it is directly joined with the camera. Thus, a compact, stable construction is assured.

In addition, the base element can comprise two rods or at least one track. Rods or tracks of metal or carbon with a high carrying capacity, e.g., up to 30 kg, are preferably used.

In addition, the bridge element and the base element can be shaped complementary to one another, e.g., the base element can be formed with two or more rods and the bridge element can have corresponding grooves. Also, an individual rod may be sufficient as a base element.

Preferably, the bridge element can be attached to the objective in a removable manner, e.g., by means of screw connections. However, a simple placement of the objective can also allow for adjustment. For this, the bridge element preferably has a recess that is adapted to the objective.

The support element can also be attached to the objective in a removable manner. For example, a clamp connection is adjustable.

Also, the support element can be mounted so that it can be moved on the base element.

In addition, the objective can be joined to the camera by means of a catch, in particular a bayonet mount. Commercially available bayonet mounts can be used for this purpose.

Also, the center of gravity of the objective can lie between the bridge element and the support element. A secure support is thus assured.

In a preferred embodiment, the optical axis of the objective can deviate by a maximum of ±10°, preferably a maximum of ±5°, from the optical axis of the camera, when the objective which is detached from the camera, is placed on the bridge element and the support element.

The objective can thus be inclined relative to the camera.

The objective can also be disposed on the bridge element so that it can rotate and/or tilt by a maximum of ±10°, preferably ±5°.

In addition, the support element can be designed so that after joining the camera and the objective, the base element need not be in contact when the camera is connected.

Finally, relative to the base element, the bridge element and/or the support element can be moved in a direction perpendicular to a lengthwise segment of the base element, and, in particular, in two directions perpendicular to one another. In this way, the movement can amount to a maximum of 5 cm, preferably a maximum of 2 cm.

By this adjusted freedom of movement, the objective can be attached simply to the camera without the need for hooks.

In an embodiment of the apparatus according to the invention, the camera can be designed so that it can be joined to exchangeable objectives. The bridge element and the support element can be designed to securely take up the most varied objectives.

An example of embodiment of the device according to the invention will be explained here on the basis of a figure, which shows:

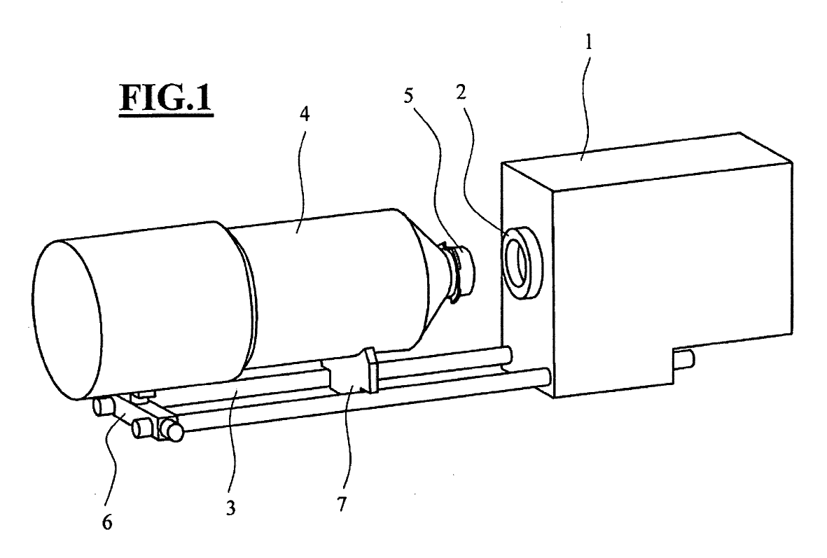

FIG. 1 an apparatus for capturing images having a camera and an objective and a device according to the invention.

FIG. 1 shows a camera 1 with a camera bayonet mount 2 and a base element 3 having two rods. An objective 4 with an objective bayonet mount 5 can also be seen. The objective is joined with the rods 3 via a bridge element 6, and, in addition, stands on rods 3 via a support element 7 attached to the objective. Since the center of gravity is also found between the bridge element 6 and the support element 7, the objective stands stably on the base element 3 without tipping. In order to place the objective 4 on camera 1, it must be moved by itself along the two rods 3 until the objective bayonet mount 5 sits in the camera bayonet mount 2, thus the screw collar of the camera bayonet mount 2 is screwed on.

Therefore, the objective 4 can be set on the camera without problem, but the following is to be observed: The camera bayonet mount 2 can have a tolerance-associated distance relative to rods 3. Thus it is advantageous that the bridge element 6 can be adjusted in height and laterally relative to objective 4. This functionality is covered by means of the bridge element. In order to avoid an overestimation based on these tolerances, the support element 7 should have a lateral play and a level play relative to rods 3. When the objective 4 is placed on bridge element 6 and support element 7, the objective is inclined, thus slightly oblique relative to camera 1. When objective 4 is moved over the rods, objective 4 slides.

Just before reaching the camera bayonet mount 2, objective 4 is slightly raised and introduced into camera bayonet mount 2. Of course, the device can also be designed so that camera bayonet mount 2 and objective bayonet mount 5 are aligned relative to one another, so that a raising/lowering or lateral movement is not required. In this way, objective 4 stands on rods 3 over the bridge element 6 and is arranged with objective bayonet mount 5 in camera bayonet mount 2. Support element 7 no longer has any contact with rods 3. When objective 4 is removed from the camera, the objective is immediately secured again by support element 7. Thus, instead of the simple, unstable single support of a bridge element on rods, a stable double support of a bridge element and a support element on rods is used. Support elements of the most varied configuration can find use. The center of gravity thus lies between the supports and maximally on one of the supports. A lateral guide of support element 7 on rods 3 may prove appropriate. Additional elements can also be attached to the base element, e.g., extension attachments. Instead of a single support element, several support elements could also find use.

1. A device for introducing an objective onto a camera, wherein the device comprises:
a base element;
a bridge element; and
a support element disposed between the base element and the objective,
wherein the objective can be moved back and forth in a direction of the camera by the bridge element on the base element.

2. The device according to claim 1, wherein the base element can be joined with a connector to the camera, or it can be directly joined with the camera.

3. The device according to claim 1, wherein the base element comprises two rods.

4. The device according to claim 1, wherein the base element comprises at least one track.

5. The device according to claim 1, wherein the bridge element and the base element are shaped complementary to one another.

6. The device according to claim 1, wherein the bridge element can be attached to the objective in a removable manner.

7. The device according to claim 1, wherein the support element can be attached to the objective in a removable manner.

8. The device according to claim 1, wherein the support element can be mounted so that it can move on the base element.

9. The device according to claim 1, wherein the objective can be joined to the camera by a catch.

10. The device according to claim 1, wherein the objective has a center of gravity that lies between the bridge element and the support element.

11. The device according to claim 1, wherein the objective has an optical axis that deviates by a maximum of ±10°, from an optical axis of the camera, when the objective is detached from the camera and placed on the bridge element and the support element.

12. The device according to claim 11, wherein the objective is inclined relative to the camera.

13. The device according to claim 1, wherein the objective can also be disposed on the bridge element so that it can rotate and/or tilt by a maximum of ±10°.

14. The device according to claim 1, wherein the support element can be designed so that after joining the camera and the objective, the base element need not be in contact when the camera is connected.

15. The device according to claim 1, wherein the bridge element and/or the support element can be moved relative to the base element in a direction perpendicular to a lengthwise segment of the base element.

16. The device according to claim 15, wherein the movement is a maximum of 5 cm.

17. An apparatus for capturing images having a camera and an objective, wherein the apparatus comprises a device that includes:
a base element;
a bridge element; and
a support element disposed between the base element and the objective,
wherein the objective can be moved back and forth in a direction of the camera by the bridge element on the base element.

18. The apparatus according to claim 17, wherein the camera can be combined with exchangeable objectives.
